(19) United States
(12) Patent Application Publication
(10) Pub. No.: US 2019/0341006 A1
(43) Pub. Date: Nov. 7, 2019

(54) INFORMATION PROCESSING APPARATUS AND SCREEN DISPLAY METHOD

(71) Applicant: LENOVO (SINGAPORE) PTE. LTD., SINGAPORE (SG)

(72) Inventors: Hidetoshi Mori, YOKOHAMA (JP); Kenji Watamura, YOKOHAMA (JP)

(73) Assignee: LENOVO (SINGAPORE) PTE. LTD., SINGAPORE (SG)

(21) Appl. No.: 16/058,037

(22) Filed: Aug. 8, 2018

(30) Foreign Application Priority Data
May 7, 2018 (JP) 2018089214

(51) Int. Cl. G09G 5/38; G06F 3/02; G09G 3/34

(52) U.S. Cl. CPC G09G 5/38; G06F 3/0481; G09G 3/3406; G06F 3/0202

(57) ABSTRACT

An information processing apparatus includes a display unit, an attachment/release detection unit configured to detect that a detachable input device is attached onto part of a display screen of the display unit, an object specification unit configured to specify an object which is disposed in an invisible region which is hidden by attachment of the input device on the display screen as a moved object and an object movement unit configured to move the moved object to a display region other than the invisible region on the display screen in a case where attachment of the input device is detected.

### FIELD OF THE INVENTION

The present invention relates to an information processing apparatus, and a screen display method and a screen display program used therein.

### BACKGROUND OF THE INVENTION

In recent years, information processing apparatuses such as a tablet-type PC, a smartphone and so forth each having a touch-panel type liquid crystal display and not having a physical keyboard are rapidly spreading. It is desirable that the display of the information processing apparatus of this kind be large when used but be miniaturized when carried. Accordingly, an information processing apparatus of the type configured to make not only chassis but also the display foldable by using a flexible display such as an organic EL (Electro Luminescence) display and so forth is proposed (see, for example, Patent Document 1).

In addition, now, a dual display type information processing apparatus in which the chassis equipped with the displays are connected together via hinges and so forth is also proposed.

[Patent Document 1] Japanese Patent No. 6261675.

### SUMMARY OF THE INVENTION

Since such information processing apparatus in which even the display is configured to be foldable and dual display type information processing apparatus as described above have no physical keyboard, there are cases where a hindrance occurs when performing, for example, an operation of inputting a long passage and so forth.

The present invention has been made in view of such circumstances as described above and aims to provide an information processing apparatus, and a screen display method and a screen display program used therein which enable improvement of input operability.

An information processing apparatus according to the first aspect of the present invention includes a display unit, an attachment detection unit configured to detect that a detachable input device is attached onto part of a display screen of the display unit, an object specification unit configured to specify an object which is disposed in an invisible region which is hidden by attachment of the input device on the display screen as an object to be moved (hereinafter, referred to as a moved object) and an object movement unit configured to move the moved object to a display region other than the invisible region on the display screen in a case where attachment of the input device is detected.

A screen display method for an information processing apparatus equipped with a display unit according to the second aspect of the present invention includes the step of detecting that a detachable input device is attached onto part of a display screen of the display unit, the step of specifying an object which is disposed in an invisible region which is hidden by attachment of the input device on the display screen as a moved object, and the step of moving the moved object to a display region other than the invisible region on the display screen in a case where attachment of the input device is detected.

The above-described aspects of the present invention have an effect that it is possible to improve the input operability.

### BRIEF DESCRIPTION OF THE DRAWINGS

FIG. 1 is one external view illustrating one example of an information processing apparatus according to one embodiment of the present invention.

FIG. 2 is another external view illustrating one example of the information processing apparatus according to one embodiment of the present invention.

FIG. 3 is a diagram illustrating one example of an input device which is made attachable to the information processing apparatus according to one embodiment of the present invention.

FIG. 4 is a schematic diagram illustrating one example of a hardware configuration of the information processing apparatus according to one embodiment of the present invention.

FIG. 5 is a functional configuration diagram illustrating one example in which functions pertaining to screen display are mainly extracted from within functions that the information processing apparatus according to one embodiment of the present invention has.

FIG. 6 is an external view illustrating one example of a case where a physical keyboard is attached, as one example of an input device, onto part of a display screen of the information processing apparatus according to one embodiment of the present invention.

FIG. 7 is a diagram illustrating one example of the screen display in a case where the input device is not attached to the information processing apparatus according to one embodiment of the present invention.

FIG. 8 is a diagram illustrating one example of the screen display in a case where the input device is attached onto the display screen of the information processing apparatus according to one embodiment of the present invention.

FIG. 9 is a diagram illustrating one example of the screen display obtained after movement of a moved object in the case where the input device is attached onto the display screen of the information processing apparatus according to one embodiment of the present invention.

FIG. 10 is an external view illustrating one example of an information processing apparatus according to another embodiment of the present invention.

### DETAILED DESCRIPTION OF THE INVENTION

In the following, an information processing apparatus, and a screen display method and a screen display program used therein according to one embodiment of the present invention will be described with reference to the drawings.

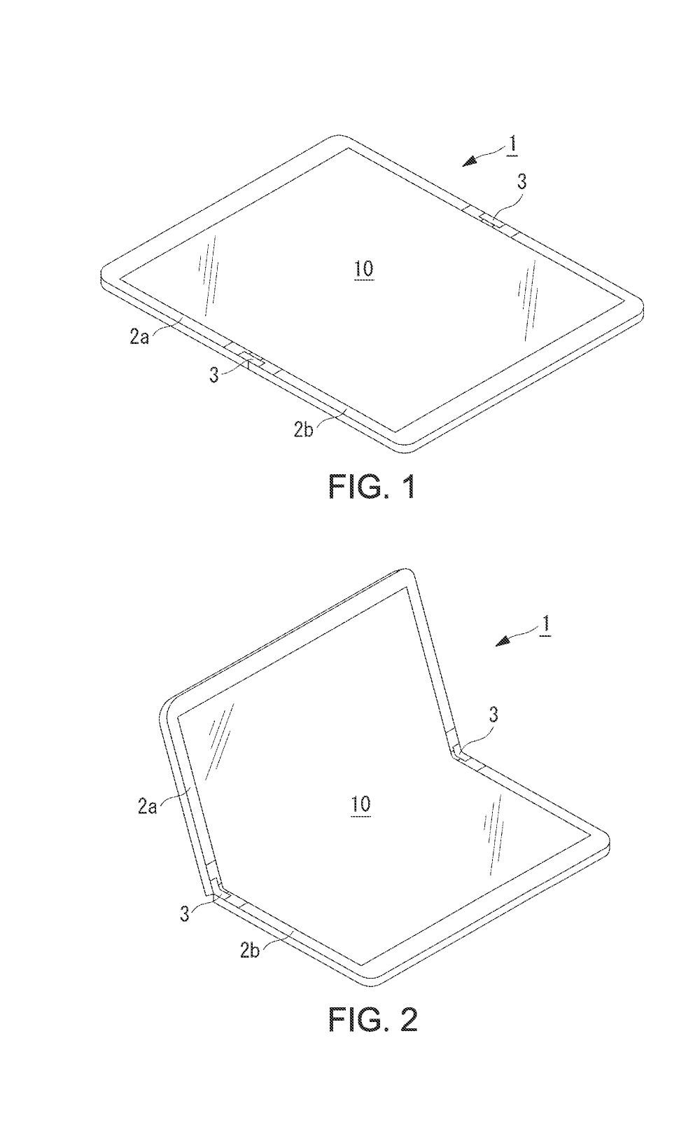

FIG. 1 and FIG. 2 are external views illustrating examples of an information processing apparatus 1 according to one embodiment of the present invention. The information processing apparatus 1 includes a first chassis 2a and a second chassis 2b. The first chassis 2a and the second chassis 2b are coupled together via coupling units 3 such as, for example, hinges and so forth and thereby the information processing apparatus 1 is configured to be foldable in two. A touch-panel type display screen 10 is disposed on inner surfaces of the first chassis 2a and the second chassis 2b. The display screen 10 is a flexible display screen which is configured by using an organic EL (Electro Luminescence) display and so forth and is configured to be foldable together with the information processing apparatus 1 in a case where the information processing apparatus 1 is folded in such a manner that the inner surfaces of the first chassis 2a and the second chassis 2b are mutually superposed.

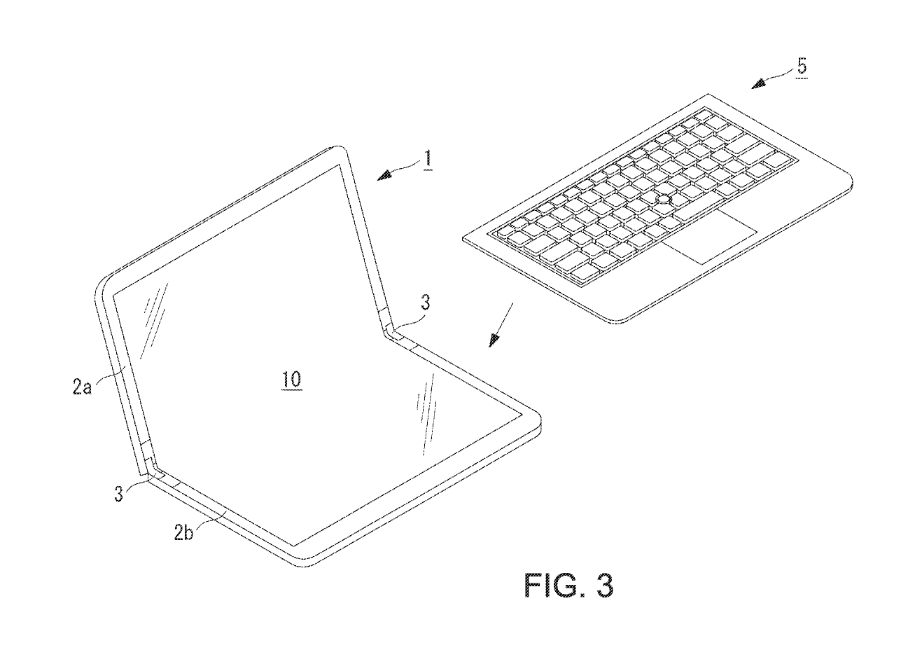

It is possible to use the information processing apparatus 1 as a tablet terminal by opening in such a manner that an angle between the inner surface of the first chassis 2a and the inner surface of the second chassis 2b becomes 180 degrees so as to bring the display screen 10 into a planar state as illustrated in FIG. 1. In addition, the information processing apparatus 1 is able to be used just like a Laptop PC by changing the angle between the inner surface of the first chassis 2a and the inner surface of the second chassis 2b as illustrated in FIG. 2. The information processing apparatus 1 is configured to enable attachment of an input device 5 such as a physical keyboard and so forth onto part of the display screen 10 as illustrated in FIG. 3. As examples of the input device 5, the physical keyboard, a touchpad, a mouse, input equipment for games and so forth may be given.

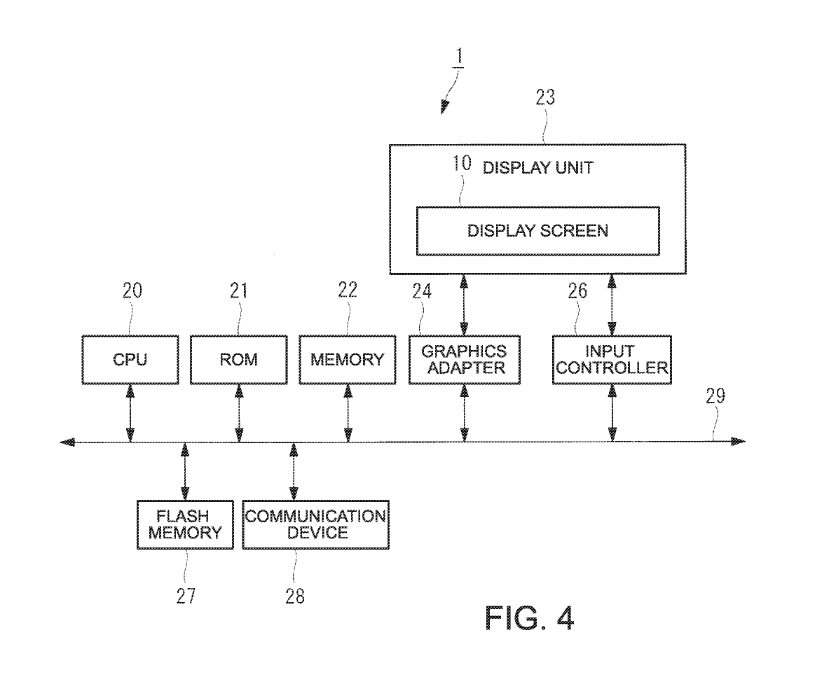

FIG. 4 is a schematic diagram illustrating one example of a hardware configuration of the information processing apparatus 1. The information processing apparatus 1 includes a CPU (Central Processing Unit) 20, a ROM (Read Only Memory) 21, a memory 22, a display unit 23, a graphics adapter 24, an input controller 26, a flash memory 27, a communication device 28 and so forth and the respective units are directly or indirectly connected with one another via a bus 29.

The CPU 20 has a function of controlling the whole information processing apparatus 1 in accordance with an OS (Operating System) which is stored in the flash memory 27 which is connected to the CPU 20 via the bus 29 and executing processes on the basis of various programs stored in the flash memory 27. In addition, the CPU 20 enables change of processing capacity in accordance with predetermined instructions.

The ROM 21 stores a BIOS (Basic Input/Output System), various kinds of data and so forth.

The memory 22 is a writable memory which is configured by a cache memory, a RAM (Random Access Memory) and so forth and is utilized as a working space for performing reading of an execution program (for example, a control program) of the CPU 20 and writing of processing data in accordance with the execution program.

The display unit 23 includes the display screen 10. The display unit 23 displays a video signal from the graphics adapter 24 on the display screen 10 as an image in accordance with control of the CPU 20. In addition, the display unit 23 detects an inputting operation that a user performs on the display screen 10 and outputs information that the inputting operation is detected to the input controller 26.

The graphics adapter 24 converts display information into a video signal and outputs the converted video signal to the display unit 23 in accordance with control of the CPU 20. The input controller 26 performs control which is based on input instructions input from the touch-panel type display screen 10.

The flash memory 27 has a function of storing, for example, the OS adapted to control the whole information processing apparatus 1, various drivers adapted to operate peripherals with hardware, specific-job-oriented applications, various kinds of data and files and so forth. Incidentally, the information processing apparatus 1 may also include another storage unit such as an HDD (Hard Disk Drive) and so forth as a storage unit which is used in place of the flash memory 27.

The communication device 28 controls communication with other devices over a network.

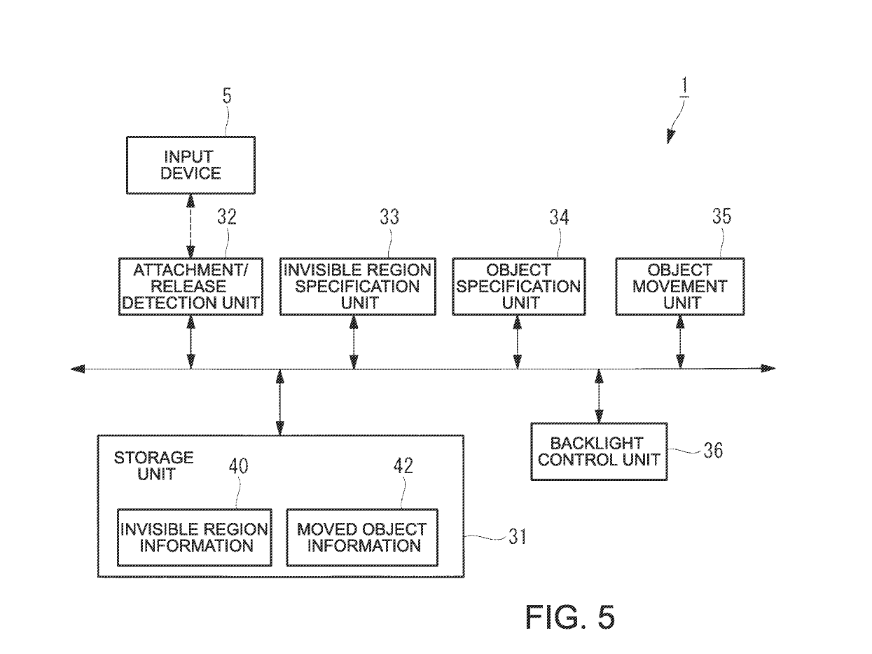

FIG. 5 is a functional configuration diagram illustrating one example in which functions pertaining to screen display are mainly extracted from within functions that the information processing apparatus 1 according to one embodiment of the present invention has. A series of processes to be executed for implementing various functions which will be described later is stored in the flash memory 27 in the form of a program (for example, a screen display program) by way of example. The CPU 20 reads this program out to the memory 22 and executes processing and arithmetic processing of information and thereby the various functions are implemented. Incidentally, the program may be applied in the form of being installed, in advance, into the flash memory 27, in the form of being provided in a state of being stored in another computer-readable storage medium, in the form of being distributed via a wired or wireless communication unit and so forth. Examples of the computer readable storage medium are a magnetic disc, a magneto-optical disc, a CD-ROM (Compact Disc-Read Only Memory), a DVD-ROM (Digital Versatile Disc-Read Only Memory), a semiconductor memory and so forth.

As illustrated in FIG. 5, the information processing apparatus 1 includes a storage unit 31, an attachment/release detection unit 32, an invisible region specification unit 33, an object specification unit 34, an object movement unit 35, and a backlight control unit 36.

The function of the storage unit 31 is implemented by, for example, the flash memory 27. Information on the input device 5 which is made detachable relative to the information processing apparatus 1 is stored in the storage unit 31. For example, invisible region information 40 in which identification information for the input device 5 is related to a size and a position of a region (in the following, referred to as an “invisible region”) on the display screen 10 which is hidden under the input device 5 in a case where the input device 5 is attached onto the part of the display screen 10 is stored in the storage unit 31.

In addition, in a case where an object to be moved (hereinafter, referred to as a moved object) is specified by the object specification unit 34 which will be described later, moved object information 42 on the moved object is stored into the storage unit 31.

The attachment/release detection unit 32 detects that the specific input device 5 is attached onto the part of the display screen 10 and detects that attachment of the input device 5 is released. For example, the function of the attachment/release detection unit 32 is implemented by a hall element (illustration thereof is omitted) which is disposed in the information processing apparatus 1. For example, a magnet (illustration thereof is omitted) is disposed on an attachment surface of the detachable input device 5 and in a case where a magnetic field generated from the magnet is detected, the attachment/release detection unit 32 detects attachment of the input device 5. In addition, in a case where the magnetic field generated from the magnet comes not to be detected, the attachment/release detection unit 32 detects release of attachment of the input device 5 (detachment of the input device 5). In a case where an attachment position where the input device 5 is attached on the display screen 10 and a size of the input device 5 are standardized, the hall element may be disposed in the information processing apparatus 1 at a position corresponding to the position of the magnet disposed on the attachment surface of the input device 5. In addition, in a case of dealing with also the input device 5 whose attachment position and size are not standardized, the hall elements may be disposed in the information processing apparatus 1 at the plurality of positions.

In addition, a technique for detecting attachment of the input device 5 is not limited to the technique using the hall element(s).

For example, the information processing apparatus 1 may be configured to enable short-distance wireless communication between the input device 5 and the information processing apparatus 1 so as to detect attachment of the input device 5 in a case where the information processing apparatus 1 receives predetermined information (for example, the identification information for the input device 5) from the input device 5. In addition, release of attachment of the input device 5 may be detected in a case where it becomes impossible to establish the wireless communication with the input device 5.

In addition, in a case where the input device 5 is attached to the information processing apparatus 1 by a physical mechanism, attachment and release of attachment of the input device 5 may be detected on the basis of an operation and so forth of the physical mechanism.

In a case where the detachable input device 5 is attached onto the part of the display screen 10, the invisible region specification unit 33 specifies a display region (in the following, referred to as an “invisible region”) which is hidden due to attachment of the input device 5.

For example, in a case where the attachment/release detection unit 32 detects attachment of the input device 5 via the short-distance wireless communication, the invisible region specification unit 33 specifies the invisible region by acquiring the invisible region which corresponds to the identification information for the input device 5 obtained via the short-distance wireless communication from the invisible region information 40.

Incidentally, a technique for specifying the invisible region is not limited to the technique described in the above example. For example, in a case where the display screen 10 is of a touch-panel type, when the input device 5 is attached onto the part of the display screen 10, attachment of the input device 5 is detected by a touch sensor and therefore a region whose presence is sensed by the touch sensor may be specified as the invisible region. In addition, the whole area of the display screen 10 which corresponds to the chassis on the side to which the input device 5 is attached may be specified as the invisible region regardless of the size of the input device 5 to be attached.

The object specification unit 34 specifies an object which is disposed in the invisible region which is specified by the invisible region specification unit 33.

A window, an icon and so forth may be given as examples of the object. Further, an application window, and a modal dialog window, a dialog window, a control window and so forth which are ranked below the application window may be given as examples of the window.

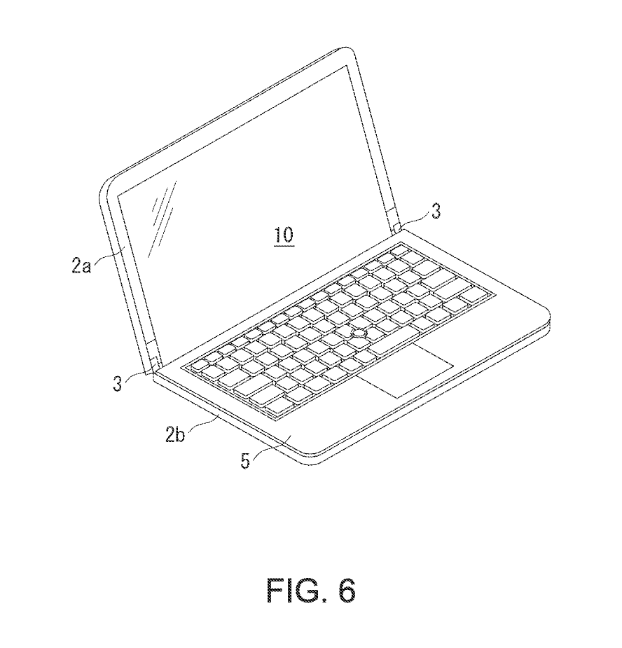

For example, in a case where the input device 5 is attached onto the part of the display screen 10 as illustrated in FIG. 6, not only visual confirmation of the objects which are disposed in the invisible region but also performance of an inputting operation become impossible for the user. Accordingly, it becomes necessary to move the objects such as the windows, the icons and so forth which are displayed in such an invisible region to a region (in the following, referred to as a “visible region”) where the user is able to confirm the objects visually. Accordingly, the object specification unit 34 specifies an object to be moved to the visible region as the moved object on the basis of a condition which is set in advance.

As one example of the “predetermined condition”, for example, a window the whole of the frame of which is disposed in the invisible region, an icon the whole of which is disposed in the invisible region and so forth may be given.

In addition, as another example of the “predetermined condition”, a window part or the whole of the frame of which is disposed in the invisible region, an icon part or the whole of which is disposed in the invisible region and so forth may be given.

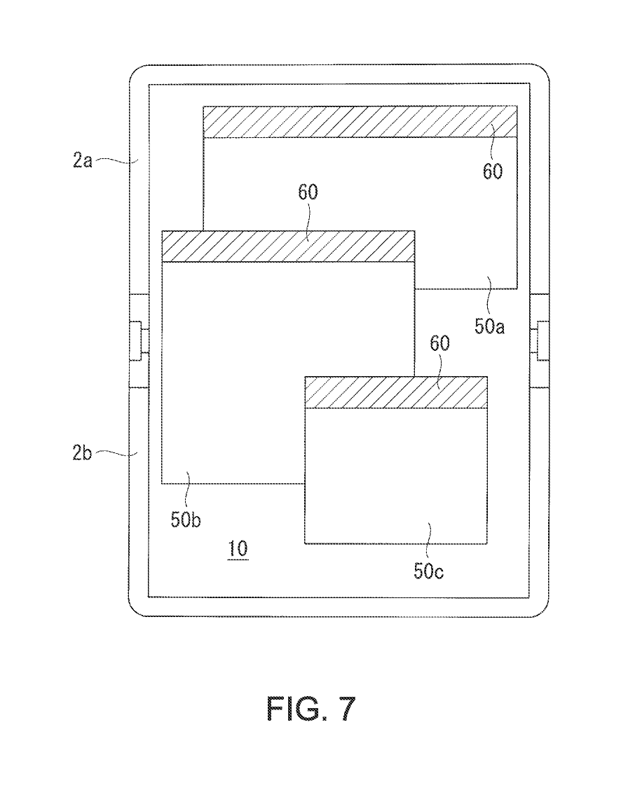

In addition, for example, as illustrated in FIG. 7, an instruction region (for example, a title bar) 60 where it is possible to instruct movement of the window concerned, size increasing and decreasing of the window concerned and so forth is provided on an upper part of the frame of each of windows 50a to 50c. Then, even in a case where most of the frame of the window concerned is disposed in the invisible region, the user is able to move that window to the region (that is, the visible region) which is not the invisible region by instructing to move that window by using the instruction region 60 on condition that the instruction region is not disposed in the invisible region. From the above, the object specification unit 34 may specify, for example, the window in which the whole of the instruction region 60 which is provided on the upper part of the frame of the window is disposed in the invisible region as the window to be moved (that is, the moved object).

The object specification unit 34 specifies the moved object and thereafter stores the moved object information 42 in which the position and the size (for example, a coordinate position of that window and a width and a height of that window) of the specified moved object are related to the object ID of the moved object into the storage unit 31.

The object movement unit 35 moves the moved object which is specified by the object specification unit 34 to the visible region which is a display region other than the invisible region on the display screen 10. In this case, the object movement unit 35 may move the moved object in such a manner that the whole of the moved object is displayed in the visible region or, in a case where the moved object is the window, may move the moved window in such a manner that at least the whole of the instruction region 60 of the moved window is displayed in the visible region.

Further, in a case where release of attachment of the input device 5 is detected by the attachment/release detection unit 32, the object movement unit 35 moves the moved object to a display position at which the moved object is displayed before moved with reference to the moved object information 42 stored in the storage unit 31. Thereby, it is possible to return the object the display position of which is forcibly moved to another position due to attachment of the input device 5 to a state obtained before attachment of the input device 5. In this case, the display position of an object which is newly added to the visible region after attachment of the input device 5 is maintained as it is. In addition, a window to which a certain change is made by the inputting operation performed by the user may be displayed at the current display position thereof without moving the display position to another position even when that window is the moved window.

In a case where attachment of the input device 5 is detected by the attachment/release detection unit 32, the backlight control unit 36 switches a backlight of the invisible region off and in a case where release of attachment of the input device 5 is detected by the attachment/release detection unit 32, the backlight control unit 36 switches the backlight of the invisible region on.

Then, a screen display method which is executed by the information processing apparatus 1 according to one embodiment of the present invention will be described with reference to FIG. 7 to FIG. 9. Incidentally, in the following, description will be made by exemplifying a case where the moved object is specified in accordance with a condition that the window whose instruction region 60 is disposed in the invisible region is specified as the moved object.

Description will be made by supposing a case where the three windows 50a to 50c are displayed on the display screen 10, for example, as illustrated in FIG. 7.

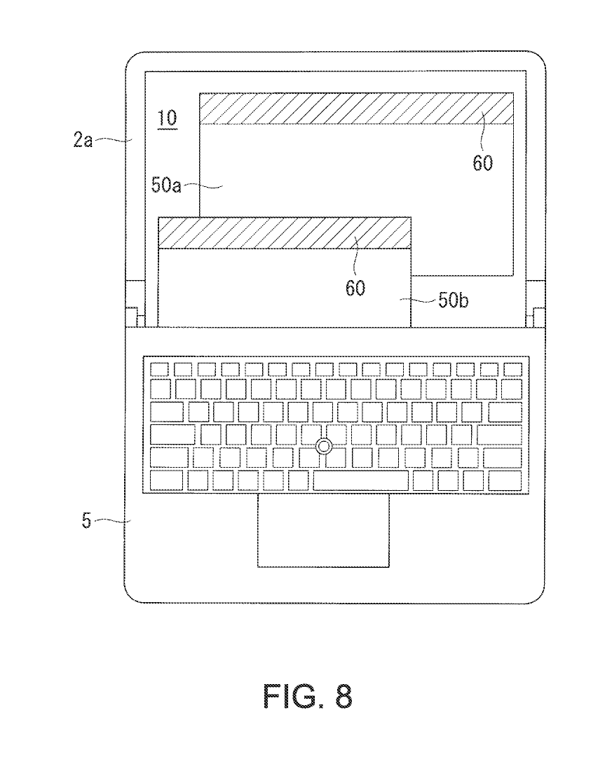

In a case where the input device 5 is attached onto the part of the display screen 10 in this state as illustrated in FIG. 8, attachment of the input device 5 is detected by the attachment/release detection unit 32 and information that the input device 5 is attached is output to the invisible region specification unit 33 and so forth.

The invisible region specification unit 33 specifies the position and the size of the invisible region on the basis of, for example, the invisible region information 40 and outputs information on the specified position and size of the invisible region to the object specification unit 34 and the backlight control unit 36.

The object specification unit 34 specifies the window 50c which is disposed in the invisible region as the moved object and stores the moved object information 42 in which the position and the size of the specified moved object are related to the identification information for the moved object into the storage unit 31.

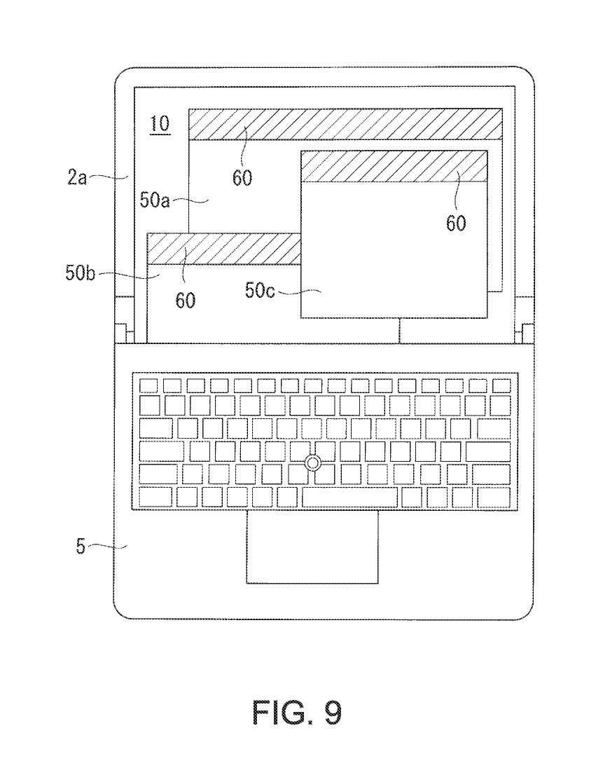

The object movement unit 35 moves the window 50c which is specified as the moved object by the object specification unit 34 to the visible region. Thereby, the whole of the window 50c is moved to the visible region, for example, as illustrated in FIG. 9.

In addition, the backlight control unit 36 switches the backlight corresponding to the invisible region off.

Then, when the input device 5 is detached from the display screen 10, release of attachment of the input device 5 is detected by the attachment/release detection unit 32 and information that attachment of the input device 5 is released is output to the object movement unit 35 and the backlight control unit 36.

The object movement unit 35 returns the moved object to the original position thereof on the basis of the moved object information 42 stored in the storage unit 31. Thereby, the window 50c comes to be displayed at a position illustrated in FIG. 7 and display on the display screen 10 comes to be returned to the arrangement of the windows 50a to 50c which is made before attachment of the input device 5.

On the other hand, the backlight control unit 36 switches the backlight corresponding to the invisible region on.

As described above, according to the information processing apparatus 1, and the screen display method and the screen display program used therein pertaining to one embodiment of the present invention, it is possible to attach the detachable input device 5 onto the part of the display screen 10 and therefore it is possible to expect improvement of the operability of the inputting operation by the user. In particular, in a case where the physical keyboard is attached as the input device 5 as illustrated in FIG. 3, it becomes possible to achieve the operability which is equivalent to that of the Laptop PC.

Further, according to one embodiment of the present invention, since the object visual confirmation of which becomes impossible or performance of the operation on which becomes impossible in a case where the input device 5 is attached onto the part of the display screen 10 is moved to the visible region, it becomes possible to eliminate inconvenience in screen arrangement which would occur due to attachment of the input device 5.

In particular, according to one embodiment of the present invention, all the objects are displayed in the visible region by moving the objects which go out of sight to the visible region in a case where the input device 5 is attached onto the part of the display screen 10, without reducing screen display. Thereby, it becomes possible to suppress a reduction in operability and so forth caused by narrowing of the display region on the display screen 10 due to attachment of the input device 5.

In addition, according to one embodiment of the present invention, since the backlight corresponding to the invisible region is switched off in the case where the input device 5 is attached onto the part of the display screen 10, it is possible to promote a reduction in power consumption.

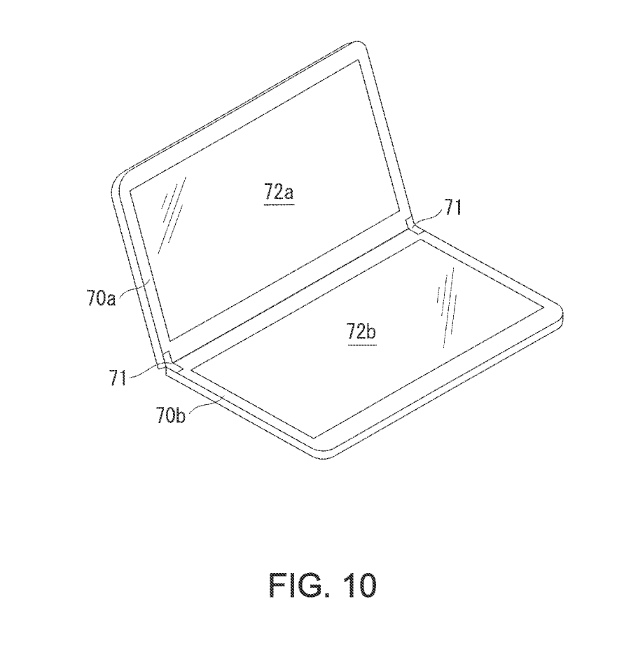

For example, in the above-described one embodiment, a case where the flexible display screen 10 is adopted is exemplified. However, the information processing apparatus 1 may have a not flexible display screen such as, for example, a liquid crystal display and so forth. In this case, the information processing apparatus 1 may be a tablet terminal equipped with, for example, a touch-panel type liquid crystal display. In addition, as illustrated in FIG. 10, as another embodiment, the information processing apparatus 1 may be an information processing apparatus in which two chassis 70a and 70b are coupled together via coupling units 71 such as the hinges and so forth and display screens 72a and 72b are disposed on inner surfaces of the chassis 70a and 70b respectively. In addition, the number of the chassis is not limited to two and the information processing apparatus 1 may also be such an information processing apparatus that three or more chassis are coupled together via the coupling units.

Although the present invention is described by using the above-described embodiments as stated above, the technical range of the present invention is not limited to the range described in the above-mentioned embodiments. It is possible to modify and/or alter the above-mentioned respective embodiments in a variety of ways within a range not deviating from the gist of the present invention and also embodiments so modified and/or altered are included in the technical range of the present invention. In addition, the above-described respective embodiments and the modified and/or altered embodiments may be mutually combined appropriately.

1. An information processing apparatus, comprising:
a display unit;
an attachment detection unit configured to detect that a detachable input device is attached onto a display screen of the display unit;
an object specification unit configured to specify an object in an invisible region, which is hidden by attachment of the input device on the display screen, as a moved object; and
an object movement unit configured to move the moved object to a display region other than the invisible region on the display screen when attachment of the input device is detected.

2. The information processing apparatus according to claim 1, wherein:
the object includes a window;
the object specification unit specifies the window in which a whole instruction region in the window is used to perform an operation, and the window is disposed in the invisible region as the moved object, and
the object movement unit moves the moved object so that a part or all of the instruction region of the specified moved object is displayed in a display region other than the invisible region.

3. The information processing apparatus according to claim 1 further, comprising:
an attachment release detection unit configured to detect that the input device is detached from the the display screen, wherein:
when release of the input device is detected, the object movement unit moves the moved object to a display position set before attachment of the input device.

4. The information processing apparatus according to any one of claim 1, further comprising:
a backlight control unit configured to switch a backlight of the invisible region off when the input device is attached and to switch the backlight of the invisible region on when the input device is released.

5. A screen display method for an information processing apparatus equipped with a display unit, comprising:
a step of detecting that a detachable input device is attached onto a display screen of the display unit;
a step of specifying an object in an invisible region, which is hidden by attachment of the input device on the display screen, as a moved object; and
a step of moving the moved object to a display region other than the invisible region on the display screen when attachment of the input device is detected.
